(19) United States
(12) Patent Application Publication
(10) Pub. No.: US 2024/0132762 A1
(43) Pub. Date: Apr. 25, 2024

(54) COVERING STRUCTURE AND METHOD OF FORMING THE SAME

(71) Applicant: Primax Electronics Ltd., Neihu (TW)

(72) Inventors: Zheng-Hong Lai, Taipei (TW); Chin-Lung Chan, Taipei (TW); Chih-Ho Hsu, Taipei (TW)

(21) Appl. No.: 18/078,230

(22) Filed: Dec. 9, 2022

(30) Foreign Application Priority Data
Oct. 20, 2022 (TW) 111140037

(51) Int. Cl. C09J 175/04; B32B 3/26; B32B 7/12; B32B 37/12; B32B 38/04

(52) U.S. Cl. CPC C09J 175/04; B32B 3/266; B32B 7/12; B32B 37/12; B32B 38/04; B32B 2038/047; B32B 2274/00; B32B 2307/7242; B32B 2310/0843; B32B 2457/00

(57) ABSTRACT

A covering structure includes at least one element, a gas impermeable film and an adhesive layer. The gas impermeable film covers the at least one element. The adhesive layer is adhered between the at least one element and the gas impermeable film, and the adhesive layer has a perforation pattern, a perforation repair pattern, or a combination thereof. A method of forming a covering structure is also provided, which includes: making a surface of an adhesive layer with a perforation pattern facing one of at least one element and a gas impermeable film to form a first structure; performing a first gas suction treatment on the first structure; making another surface of the adhesive layer of the first structure facing the other thereof to form a second structure; and performing a second gas suction treatment on the second structure.

### FIELD OF THE INVENTION

The present disclosure relates to a covering structure, and more particularly, to a structure for covering an element with a gas impermeable film.

### BACKGROUND OF THE INVENTION

In order to make a keyboard device have good waterproof and dustproof performance and good appearance, selection of material for covering the keyboard device and structural design of the keyboard device are keys to determine the above effects. However, currently available keyboard devices still have their shortcomings. For example, a commercially available product is a keyboard device covered with a cover layer including a gas impermeable film and a breathable woven fabric, which is designed that only a center portion of a keycap is adhered to the cover layer, and a peripheral portion of the keycap is not adhered to the cover layer; however, such the structural design may result in poor appearance of the cover layer when the keycap is pressed (e.g., the center is recessed and the periphery is raised). In another commercially available product, a keyboard device is covered with a breathable woven fabric treated with water repellent treatment, but its waterproof performance is limited and there is still room for improvement.

### SUMMARY OF THE INVENTION

The present disclosure provides a covering structure, which includes at least one element, a gas impermeable film and an adhesive layer. The gas impermeable film covers the at least one element. The adhesive layer is adhered between the at least one element and the gas impermeable film, in which the adhesive layer has a perforation pattern, a perforation repair pattern, or a combination thereof.

In some embodiments of the present disclosure, the at least one element includes a plurality of keycaps, a C piece of a notebook computer, or a combination thereof.

In some embodiments of the present disclosure, the adhesive layer includes a hot melt adhesive layer having the perforation repair pattern.

In some embodiments of the present disclosure, the hot melt adhesive layer includes thermoplastic polyurethane (TPU).

In some embodiments of the present disclosure, the adhesive layer includes a pressure-sensitive adhesive layer having the perforation pattern.

In some embodiments of the present disclosure, the adhesive layer includes two pressure-sensitive adhesive layers and a substrate sandwiched between the two pressure-sensitive adhesive layers, and the two pressure-sensitive adhesive layers and the substrate have the perforation pattern.

The present disclosure also provides a method of forming a covering structure, which includes: making a surface of an adhesive layer with a perforation pattern facing one of at least one element and a gas impermeable film to form a first structure; performing a first gas suction treatment on the first structure; making another surface of the adhesive layer of the first structure facing the other of the at least one element and the gas impermeable film to form a second structure; and performing a second gas suction treatment on the second structure.

In some embodiments of the present disclosure, the method further includes: performing a laser engraving process, a die-punching process or a combination thereof on an original adhesive layer to form the adhesive layer having the perforation pattern.

In some embodiments of the present disclosure, the adhesive layer is a hot melt adhesive layer having the perforation pattern, and the method further includes: performing a first heat treatment on the hot melt adhesive layer after the first gas suction treatment, so that the hot melt adhesive layer is pre-bonded to the one of the at least one element and the gas impermeable film; and performing a second heat treatment on the hot melt adhesive layer after the second gas suction treatment, so that the hot melt adhesive layer is adhered between the at least one element and the gas impermeable film, in which after the second heat treatment is performed, the perforation pattern is filled and repaired to form a perforation repair pattern.

In some embodiments of the present disclosure, the adhesive layer includes at least one pressure-sensitive adhesive layer.

In some embodiments of the present disclosure, the adhesive layer includes two pressure-sensitive adhesive layers and a substrate sandwiched between the two pressure-sensitive adhesive layers, and the two pressure-sensitive adhesive layers and the substrate have the perforation pattern.

In some embodiments of the present disclosure, the at least one element includes a plurality of keycaps, a C piece of a notebook computer, or a combination thereof.

### BRIEF DESCRIPTION OF THE DRAWINGS

Aspects of the present disclosure are best understood from the following embodiments, read in conjunction with the accompanying drawings. It should be understood, however, that in accordance with common practice in the industry, various features have not necessarily been drawn to scale. Indeed, shapes of the various features may be suitably adjusted for clarity, and dimensions of the various features may be arbitrarily increased or decreased.

FIG. 1 is a schematic top view of perforation patterns according to some embodiments of the present invention.

FIGS. 2 to 5 are schematic cross-sectional views of a method of forming a covering structure at various process stages according to an embodiment of the present invention.

FIG. 6 is a photograph of a covering structure formed by a method of forming a covering structure according to an embodiment of the present invention.

FIG. 7 is a schematic cross-sectional view of a method of forming a covering structure at a process stage subsequent to FIG. 5 according to an embodiment of the present invention.

FIG. 8 is a photograph of hot melt adhesive layers respectively with different perforation repair patterns and keycaps according to an embodiment of the present invention.

FIG. 9 is a schematic cross-sectional view of an adhesive layer according to an embodiment of the present invention.

### DETAIL DESCRIPTION OF THE PREFERRED EMBODIMENT

The advantages and features of the present disclosure and the method for achieving the same will be described in more detail with reference to exemplary embodiments and the accompanying drawings to make it easier to understand. However, the present disclosure can be implemented in different forms and should not be construed as being limited to the embodiments set forth herein. On the contrary, for those skilled in the art, the provided embodiments will make this disclosure more thorough, comprehensive and complete to convey the scope of the present disclosure.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180 degrees, the relationship between the one element and the other element may change from “beneath” to “over.” In addition, the spatially relative descriptions used herein should be interpreted the same.

As described in the related art, the commercially available keyboard devices still have their shortcomings, and it is difficult to have good waterproof and dustproof performance and good appearance at the same time. Accordingly, the present invention provides a novel covering structure and a method of forming the same to solve the above-mentioned issues.

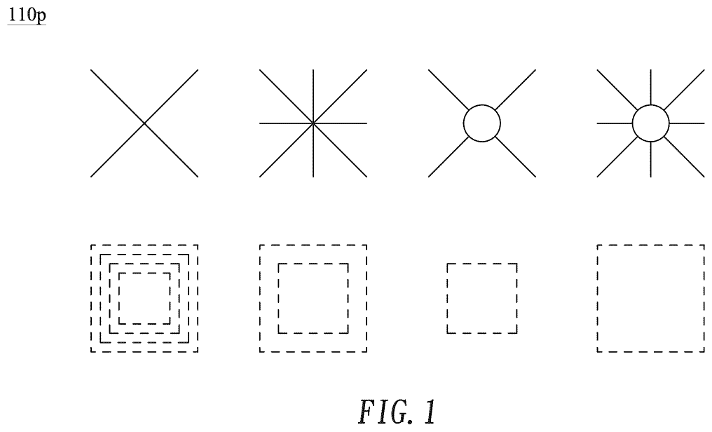

Various embodiments of the method of forming the covering structure of the present invention are described in detail below. FIG. 1 is a schematic top view of perforation patterns according to some embodiments of the present invention. As shown in FIG. 1, the perforation pattern (or can be referred to as a through hole pattern) 110p can be designed in various patterns. In some embodiments, a laser engraving process, a die-punching process, another suitable process, or a combination thereof is performed on an original adhesive layer (not shown) to form the perforation pattern 110p shown in FIG. 1.

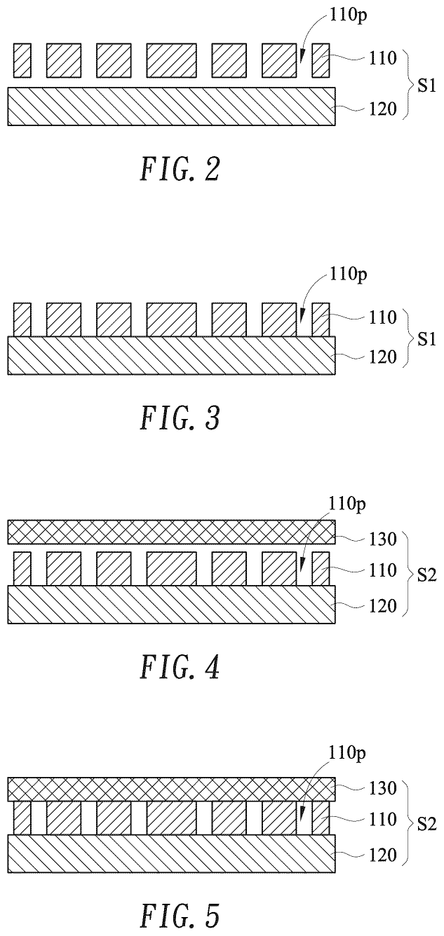

FIGS. 2 to 5 are schematic cross-sectional views of a method of forming a covering structure at various process stages according to an embodiment of the present invention. As shown in FIG. 2, first, a surface of the adhesive layer 110 having the perforation pattern 110p is made to face one of at least one element and a gas impermeable film (e.g., the element 120) to form a first structure 51 (e.g., including the adhesive layer 110 and the element 120). In some embodiments, at this time, the surface of the adhesive layer 110 may be partially in contact with the element 120 but not completely in contact with the element 120. In some embodiments, the at least one element includes a plurality of keycaps, a C piece of a notebook computer (e.g., a case surrounding a keyboard module and a touchpad), or a combination thereof, but the present invention is not limited thereto.

As shown in FIGS. 2 and 3, the first gas suction treatment is performed on the first structure 51. Since the adhesive layer 110 has the perforation pattern 110p, all the air between the adhesive layer 110 and the element 120 can be easily removed by the first gas suction treatment, so that the surface of the adhesive layer 110 is completely in contact with the element 120, and no air remains between the adhesive layer 110 and the element 120.

As shown in FIG. 3 and FIG. 4, another surface of the adhesive layer 110 of the first structure 10 is made to face the other of the at least one element and the gas impermeable film (e.g., the gas impermeable film 130) to form a second structure S2 (e.g., including the adhesive layer 110, the element 120 and the gas impermeable film 130). In some embodiments, at this time, the other surface of the adhesive layer 110 may be partially in contact with the gas impermeable film 130 but not completely in contact with the gas impermeable film 130. In some embodiments, the gas impermeable film 130 is made of a flexible material, such as polyurethane, thermoplastic polyurethane or another suitable flexible material, but the present invention is not limited thereto, and the gas impermeable film 130 can be made of another suitable material.

As shown in FIG. 4 and FIG. 5, a second gas suction treatment is performed on the second structure S2. Since the adhesive layer 110 has the perforation pattern 110p, all the air between the adhesive layer 110 and the gas impermeable film 130 can be easily removed by the second gas suction treatment, so that the other surface of the adhesive layer 110 is completely in contact with the gas impermeable film 130, and no air remains between the adhesive layer 110 and the gas impermeable film 130.

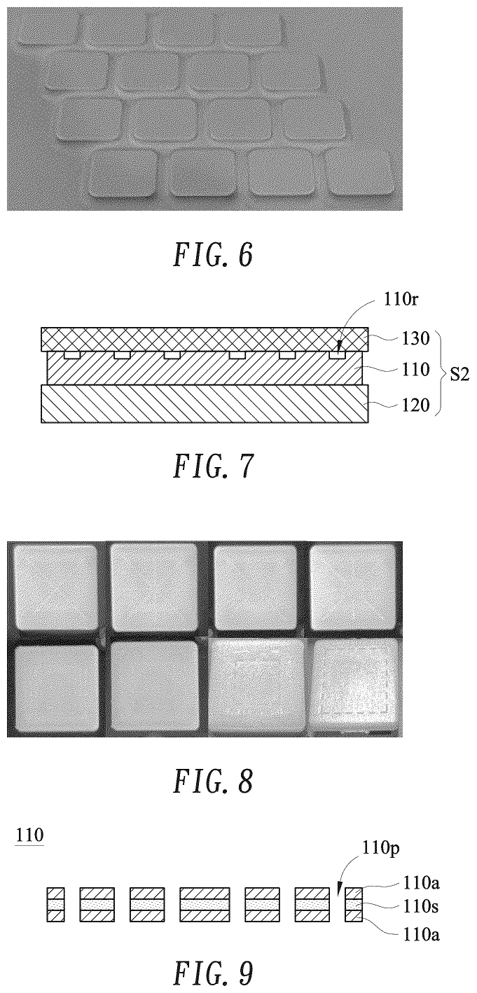

It should be noted that a traditional covering structure formed by using an original adhesive layer without a perforation pattern is prone to have many appearance defects caused by entrained air, but the present invention can avoid the aforementioned phenomenon. FIG. 6 is a photograph of a covering structure formed by a method of forming a covering structure according to an embodiment of the present invention. As shown in FIG. 6, the covering structure formed by the method disclosed in the present invention using the adhesive layer 110 with the perforation pattern 110p of the present invention has good appearance, and does not have any appearance defects due to entrained air and any appearance defects due to the perforation pattern 110p.

FIG. 7 is a schematic cross-sectional view of a method of forming a covering structure at a process stage subsequent to FIG. 5 according to an embodiment of the present invention. In some embodiments, the adhesive layer 110 shown in FIGS. 2 to 5 is a hot melt adhesive layer with the perforation pattern 110p, and the method further includes: after the first gas suction treatment (refer to FIG. 2 and FIG. 3) is performed, a first heat treatment is performed on the hot melt adhesive layer, so that the hot melt adhesive layer is pre-bonded to one of the at least one element and the gas impermeable film (e.g., the element 120); and after the second gas suction treatment (refer to FIG. 4 and FIG. 5) is performed, as shown in FIGS. 5 and 7, a second heat treatment is performed on the hot melt adhesive layer, so that the hot melt adhesive layer is adhered between the at least one element 120 and the gas impermeable film 130.

In some embodiments, as shown in FIGS. 5 and 7, after the second heat treatment is performed, the perforation pattern 110p is filled and repaired to form a perforation repair pattern 110r. Specifically, the hot melt adhesive layer has high fluidity when the second heat treatment is performed, so that the perforation pattern 110p can be filled and repaired to form the perforation repair pattern 110r (as shown in FIG. 7, the pattern with recesses). However, after the hot melt adhesive layer fills and repairs the perforation pattern 110p, a perforation repair pattern with another structure may also be formed, so the present invention is not limited to the embodiment shown in FIG. 7. FIG. 8 is a photograph of hot melt adhesive layers respectively with different perforation repair patterns and keycaps according to an embodiment of the present invention. As shown in FIG. 8, the perforation repair pattern has a white line pattern.

In some embodiments, the adhesive layer 110 shown in FIGS. 2 to 5 includes at least one pressure-sensitive adhesive layer; during or after performing the first gas suction treatment (refer to FIG. 2 and FIG. 3), the pressure-sensitive adhesive layer is adhered to one of the at least one element and the gas impermeable film (e.g., the element 120); during or after performing the second gas suction treatment (refer to FIG. 4 and FIG. 5), the pressure-sensitive adhesive layer is adhered to the other of the at least one element and the gas impermeable film (e.g., the gas impermeable film 130). In some embodiments, as shown in FIG. 5, after the pressure-sensitive adhesive layer has been adhered between the at least one element 120 and the gas impermeable film 130, there is still the perforated pattern 110p in the pressure-sensitive adhesive layer.

FIG. 9 is a schematic cross-sectional view of an adhesive layer according to an embodiment of the present invention. In some embodiments, the adhesive layer 110 includes two pressure-sensitive adhesive layers 110a and a substrate 110s, and the substrate 110s is sandwiched between the two pressure-sensitive adhesive layers 110a, and the two pressure-sensitive adhesive layers 110a and the substrate 110s has the perforation pattern 110p. The adhesive layer 110 shown in FIG. 9 can also be used in the forming method shown in FIGS. 2 to 5 for forming the covering structure, which will not be described in detail below.

As can be seen from the above, the present invention can form the cover structure that the gas impermeable film 130 is completely adhered to the element 120 (e.g., the keycaps, the C piece of the notebook computer or a combination thereof) by the method disclosed in the present invention using the gas impermeable film 130 and the adhesive layer 110 having the perforation pattern, which has good waterproof and dustproof performance and good appearance.

Various embodiments of the covering structure of the present invention are described in detail below. Please refer to FIGS. 5 and 7, the covering structure includes at least one element 120, a gas impermeable film 130 and an adhesive layer 110.

In some embodiments, the at least one element 120 includes a plurality of keycaps, a C piece of a notebook computer (e.g., a casing surrounding a keyboard module and a touchpad), another suitable element, or a combination thereof.

The gas impermeable film 130 covers the at least one element 120. The gas impermeable film 130 can provide good waterproof and dustproof performance. In some embodiments, the gas impermeable film 130 is made of a flexible material, such as polyurethane, thermoplastic polyurethane or another suitable flexible material, however, the present invention is not limited thereto, and the gas impermeable film may also be made of another material 130.

The adhesive layer 110 is adhered between the at least one element 120 and the gas impermeable film 130, in which the adhesive layer 110 has a perforation pattern 110p (as shown in FIG. 5), a perforation repair pattern 110r (as shown in FIG. 7), or a combination thereof. In some embodiments, as shown in FIG. 5, the adhesive layer 110 includes a pressure-sensitive adhesive layer, and the pressure-sensitive adhesive layer has the perforation pattern 110p. In some embodiments, the pressure-sensitive adhesive layer is, for example, an elastomer-type pressure-sensitive adhesive layer or a resin-type pressure-sensitive adhesive layer (e.g., an acrylic pressure-sensitive adhesive layer). In some embodiments, as shown in FIG. 7, the adhesive layer 110 includes a hot melt adhesive layer, and the hot melt adhesive layer has the perforation repair pattern 110r. In some embodiments, the hot melt layer includes thermoplastic polyurethane or another suitable material. In some embodiments, the “perforation repair pattern 110r” may have a pattern with recesses as shown in FIG. 7 in a cross-sectional view and/or a pattern with a color different from that of other portions of the adhesive layer as shown in FIG. 8 in a top view.

In some embodiments, as shown in FIG. 9, the adhesive layer 110 includes two pressure-sensitive adhesive layers 110a and a substrate 110s, and the substrate 110s is sandwiched between the two pressure-sensitive adhesive layers 110a, and the two pressure-sensitive adhesive layer 110a and the substrate 110s have the perforation pattern 110p. In some embodiments, the pressure-sensitive adhesive layer 110a is, for example, an elastomer-type pressure-sensitive adhesive layer or a resin-type pressure-sensitive adhesive layer (e.g., an acrylic pressure-sensitive adhesive layer). In some embodiments, a material of the substrate 110s is, for example, cotton paper, PET, PVC film, non-woven fabric, foam or another suitable material. In some embodiments, the adhesive layer 110 shown in FIG. 9 is formed by coating the pressure-sensitive adhesive layers respectively on both sides of the substrate and then performing a perforation process.

However, the above are only the preferred embodiments of the present disclosure, and should not be used to limit the scope of implementation of the present disclosure, that is, simple equivalent changes and modifications made in accordance with claims and description of the present disclosure are still within the scope of the present disclosure. In addition, any embodiment of the present disclosure or claim does not need to achieve all the objectives or advantages disclosed in the present disclosure. In addition, the abstract and the title are not used to limit the scope of claims of the present disclosure.

What is claimed is:

1. A covering structure, comprising:
at least one element;
a gas impermeable film covering the at least one element; and
an adhesive layer adhered between the at least one element and the gas impermeable film, wherein the adhesive layer has a perforation pattern, a perforation repair pattern or a combination thereof.

2. The covering structure of claim 1, wherein the at least one element comprises a plurality of keycaps, a C piece of a notebook computer, or a combination thereof.

3. The covering structure of claim 1, wherein the adhesive layer comprises a hot melt adhesive layer having the perforation repair pattern.

4. The covering structure of claim 2, wherein the hot melt adhesive layer comprises thermoplastic polyurethane (TPU).

5. The covering structure of claim 1, wherein the adhesive layer comprises a pressure-sensitive adhesive layer having the perforation pattern.

6. The covering structure of claim 1, wherein the adhesive layer comprises two pressure-sensitive adhesive layers and a substrate sandwiched between the two pressure-sensitive adhesive layers, and the two pressure-sensitive adhesive layers and the substrate have the perforation pattern.

7. A method of forming a covering structure, comprising:
making a surface of an adhesive layer having a perforation pattern facing one of at least one element and a gas impermeable film to form a first structure;
performing a first gas suction treatment on the first structure;
making another surface of the adhesive layer of the first structure facing the other of the at least one element and the gas impermeable film to form a second structure; and
performing a second gas suction treatment on the second structure.

8. The method of claim 7, further comprising:
performing a laser engraving process, a die-punching process or a combination thereof on an original adhesive layer to form the adhesive layer having the perforation pattern.

9. The method of claim 7, wherein the adhesive layer is a hot melt adhesive layer having the perforation pattern, and the method further comprises:
performing a first heat treatment on the hot melt adhesive layer after the first gas suction treatment, so that the hot melt adhesive layer is pre-bonded to the one of the at least one element and the gas impermeable film; and
performing a second heat treatment on the hot melt adhesive layer after the second gas suction treatment, so that the hot melt adhesive layer is adhered between the at least one element and the gas impermeable film, wherein after the second heat treatment is performed, the perforation pattern is filled and repaired to form a perforation repair pattern.

10. The method of claim 7, wherein the adhesive layer comprises at least one pressure-sensitive adhesive layer.

11. The method of claim 7, wherein the adhesive layer comprises two pressure-sensitive adhesive layers and a substrate sandwiched between the two pressure-sensitive adhesive layers, and the two pressure-sensitive adhesive layers and the substrate have the perforation pattern.

12. The method of claim 7, wherein the at least one element comprises a plurality of keycaps, a C piece of a notebook computer, or a combination thereof.
